(19) United States
(12) Patent Application Publication
(10) Pub. No.: US 2026/0086644 A1
(43) Pub. Date: Mar. 26, 2026

(54) Haptic System for Sculpting in Virtual Reality

(71) Applicant: The Penn State Research Foundation, University Park, PA (US)

(72) Inventor: Bonnie Susan Collura, Bellefonte, PA (US)

(73) Assignee: The Penn State Research Foundation, University Park, PA (US)

(21) Appl. No.: 19/331,454

(22) Filed: Sep. 17, 2025

Related U.S. Application Data
(60) Provisional application No. 63/696,937, filed on Sep. 20, 2024.

(51) Int. Cl. G06F 3/01; G06F 3/0346; G06T 19/20

(52) U.S. Cl. CPC G06F 3/016; G06F 3/014; G06F 3/0346; G06T 19/20; G06T 2219/2021

(57) ABSTRACT

Embodiments can relate to a system for sculpting in virtual reality. The system can include a glove, a motion sensor, a haptic feedback device, and a processor operatively connected to a virtual reality (VR) display. The processor can be configured to, generate a virtual object in space, receive motion data from the motion sensor, the motion data being representative of a location of the glove relative to a location of the virtual object, cause the haptic feedback device to generate tactile sensations when the location of the glove intersects the location of the virtual object, reshape the virtual object based on interactive engagement between the glove and the virtual object, the interactive engagement pertaining to a degree with which the glove transects into a volume of space of the virtual object, and generate a three-dimensional (3D) image of the virtual object for display by the VR display.

### CROSS-REFERENCE TO RELATED APPLICATIONS

This patent application is related to and claims the benefit of priority of U.S. provisional patent application No. 63/696,937 , filed on Sep. 20, 2024, the entire contents of which are incorporated herein by reference.

### FIELD OF THE INVENTION

Embodiments can relate to a system for sculpting in virtual reality (VR).

### BACKGROUND OF THE INVENTION

Blind or Visually Impaired (BVI) artists are often overlooked and underrepresented.

Their unique way of understanding art is very different from a sighted individual, which can create a disconnect. Known systems related to virtual reality systems in this field of technology can be appreciated from U.S. Pat. Nos. 6,067,244A, 10,127,964B2, CN107533860B, RU 186397U1, U.S. Pat. No. 10,894,204B2, KR 102004371B1, and Soft Robotic Glove for Kinesthetic Haptic Feedback in Virtual Reality Environments by Jadhav S, Kannanda V, Kang B, Tolley M, Schulze J.

### SUMMARY OF THE INVENTION

Embodiments can relate to a system for sculpting in virtual reality. The system can include a glove, including a forehand portion, a backhand portion, and finger portions. The system can include a motion sensor. The system can include a haptic feedback device, including a plurality of flex sensors and a plurality of haptic motors. The system can include a processor operatively connected to the motion sensor, the haptic feedback device, and a virtual reality (VR) display. The processor can be configured to generate a virtual object in space. The processor can be configured to receive motion data from the motion sensor. The motion data can be representative of a location of the glove relative to a location of the virtual object. The processor can be configured to cause the haptic feedback device to generate tactile sensations when the location of the glove intersects the location of the virtual object. The processor can be configured to reshape the virtual object based on interactive engagement between the glove and the virtual object. The interactive engagement can pertain to a degree with which the glove transects into a volume of space of the virtual object. The processor can be configured to generate a three-dimensional (3D) image of the virtual object for display by the VR display.

In some embodiments, the system can include the VR display.

In some embodiments, the VR display can be a VR headset.

In some embodiments, the processor can be configured to transmit the 3D image to the VR display.

In some embodiments, the processor can be configured reshape the virtual object in real-time, via a batch-processing technique, continuously, periodically, or at a pre-determined time.

In some embodiments, the motion data can be representative of a location of the forehand portion, the backhand portion, and/or the finger portions.

In some embodiments, the tactile sensations can be generated when one or more locations of the forehand portion, the backhand portion, and/or the finger portions intersect with one or more locations of the virtual object.

In some embodiments, one or more surfaces of the virtual object can be reshaped based on one or more interactive engagements between the forehand portion, the backhand portion, and/or the finger portions and the one or more surfaces. The one or more interactive engagements can pertain to one or more degrees with which the forehand portion, the backhand portion, and/or the finger portions transect into one or more volumes of space of the virtual object.

In some embodiments, the processor can be configured to generate plural virtual objects and plural 3D images of the plural virtual objects.

In some embodiments, the motion sensor can be located in or on the glove.

In some embodiments, at least one flex sensor can be located in or on one or more finger potions.

In some embodiments, the one or more haptic motors can be located in or on the forehand portion.

An exemplary embodiment can relate to a method for sculpting in virtual reality. The method can involve generating a virtual object in space. The method can involve receiving motion data representative of a location of a glove relative to a location of the virtual object. The method can involve generating tactile sensations when the location of the glove intersects the location of the virtual object. The method can involve reshaping the virtual object based on interactive engagement between the glove and the virtual object. The interactive engagement can pertain to a degree with which the glove transects into a volume of space of the virtual object. The method can involve generating a three-dimensional (3D) image of the virtual object for display by a VR display.

In some embodiments, the VR display can be a VR headset.

In some embodiments, the method can involve transmitting the 3D image to the VR display.

In some embodiments, reshaping the virtual object can involve reshaping the virtual object in real-time, via a batch-processing technique, continuously, periodically, or at a pre-determined time.

In some embodiments, the motion data can be representative of a location of a forehand portion of the glove, a backhand portion of the glove, and/or finger portions of the glove.

In some embodiments, generating tactile sensations can involve generating tactile sensations when one or more locations of the forehand portion, the backhand portion, and/or the finger portions intersect with one or more locations of the virtual object.

In some embodiments, reshaping the virtual object can involve reshaping one or more surfaces of the virtual object based on one or more interactive engagements between the forehand portion, the backhand portion, and/or the finger portions and the one or more surfaces. The one or more interactive engagements can pertain to one or more degrees with which the forehand portion, the backhand portion, and/or the finger portions transect into one or more volumes of space of the virtual object.

In some embodiments, the method can involve generating plural virtual objects and generating plural 3D images of the plural virtual objects.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1 shows an exemplary embodiment of the system.

FIG. 2 shows an exemplary circuit diagram for an embodiment of the system.

FIG. 3 shows an exemplary PCB schematic for an embodiment of the system.

FIG. 4 shows a prototype of an exemplary embodiment of the system.

FIG. 5 shows results of a power analysis of an exemplary embodiment of the system.

FIG. 6 shows exemplary hardware and wireless communication set-ups for an embodiment of the system.

FIG. 7 shows an exemplary an application loop for an embodiment of the system.

FIG. 8 shows an exemplary initialization approach for an embodiment of the system.

FIG. 9 shows exemplary placement of sensors for an embodiment of the system.

FIG. 10 shows an example layered configuration for an embodiment of the glove.

FIG. 11 shows an exemplary controller fixture for an embodiment of the system.

FIG. 12 shows another exemplary controller fixture for an embodiment of the system.

FIG. 13 shows another exemplary controller fixture for an embodiment of the system.

FIGS. 14-16 show an exemplary platform design for an embodiment of the system.

FIG. 17 shows exemplary placement of system components on a glove.

FIG. 18 shows fully assembled gloves.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of the present invention. The scope of the present invention is not limited by this description.

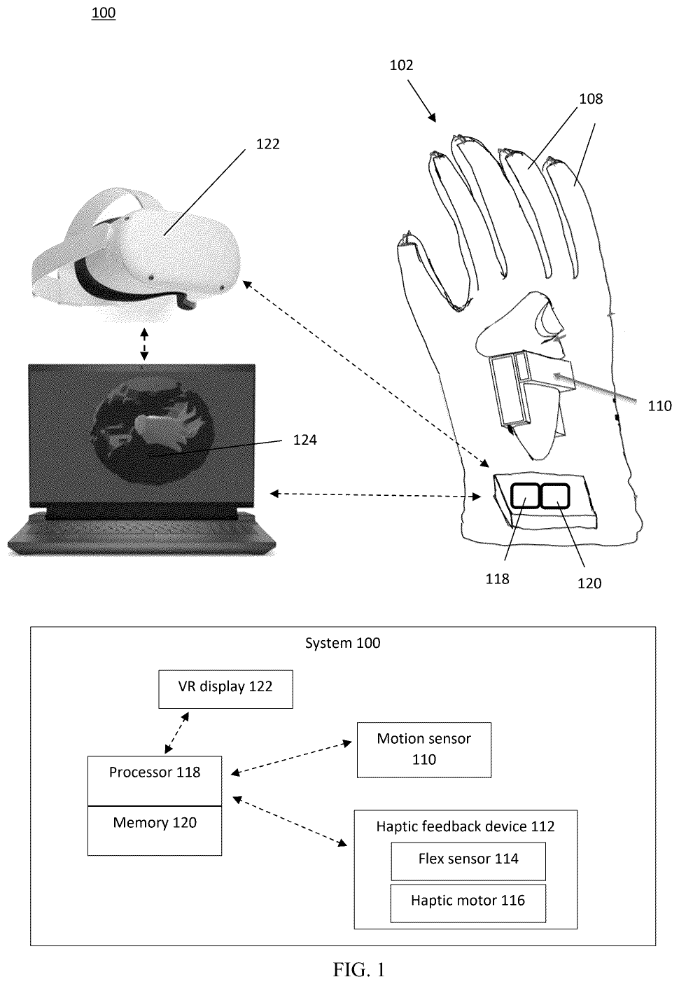

Referring to FIG. 1, embodiments can relate to a system 100 for sculpting in virtual reality. The system 100 can include one or more gloves 102. The glove 102 can be garment configured to be donned by a user hand. For instance, the glove 102 can have a forehand portion 106 (e.g., configured to cover or make contact with one or more palmer regions of the hand), a backhand portion 104 (e.g., configured to cover or make contact with one or more dorsal regions of the hand), and at least one finger portion 108. While exemplary embodiments may describe and illustrate use of the system 100 with a glove 102, it is understood that the system 100 can be implemented without a glove-like garment. For instance, a “skeleton” of the sensor and feedback system can be made and placed on, wrapped on, or otherwise attached to a user hand instead of a glove 102.

The system 100 can include one or more motion sensors 110. The motion sensor 110 can be one or more of an accelerometer, an infrared sensor, a microwave sensor, an ultrasonic sensor, a vibrational sensor, a gyroscopic sensor, a position sensor, computer vision video motion sensor, etc. The motion sensor 110 can include any number of sensors, be configured to use sensor fusion techniques, be configured to use multi-variant analytics, be configured to use predictive analytics, etc. It is contemplated for the motion sensor 110 to be placed in or on the glove 102, but it is understood that the motion sensor 110 can be located at a position that is not in or on the glove 102. It is also understood that the system 100 can include plural motion sensors 110, any one or combination of which can be in/on the glove 102 and any one or combination of which can located at a position that is not in/on the glove 102. The motion sensor 110 can be configured to track location and motion of the glove 102 and/or portion(s) of the glove 102. This can be done by establishing a reference coordinate frame (e.g., a four-dimensional spatial-time frame). This can be achieved by using Global Positioning System (GPS) technology, generating an 3D virtual mesh, etc.

The system can include one or more haptic feedback devices 112. The haptic feedback device 112 can include one or more flex sensors 114. The flex sensor 114 can be a sensor strip that detects motion based on strain-e.g., as the sensor is bent or flexed, sensor characteristic(s) change (e.g., resistance, conductivity, etc.) due to the strain, which can be used to detect the degree of flexure. This can be achieved by using a strip of piezoelectric sensor material, for example. The flex sensor(s) 114 can be located in or on a portion of the glove 102. It is understood that there can be any number of flex sensors 114 located on a finger portion 108, any number of flex sensors 114 located on any number of finger portions 108, any number of flex sensors 114 located on a dorsal side of a finger portion 108, any number of flex sensors 114 located on a palmer side of a finger portion 108, etc. The number of flex sensors 114 for one finger portion 108 can be the same as or different from the number of flex sensors 114 for another finger portion 108. Some finger portions 108 may have no flex sensors 114. It is contemplated for the flex sensor(s) 114 to be located on a dorsal side of the finger portions 108 of the glove 102 to as to detect and monitor flexure if a user's fingers.

The haptic feedback device 112 can include one or more haptic motors 116. The haptic motor 116 can be configured to generate one or more tactile sensations for a user. The tactile sensation can include pressure, heat, coolness, tingling, vibration, friction, etc. The haptic motor 116 can generate electromagnetic energy, mechanical energy, electrical energy, etc. to stimulate nerves in a user's skin, thereby inducing tactile sensations. The haptic motor(s) 116 can be located in or on a potion of the glove 102. It is understood that there can be any number of haptic motors 116 located on a palmer side of the glove 102, any number of haptic motors 116 located on a dorsal side of the glove XC, etc. The number of haptic motors 116 for a palmer side of the glove 102 can be the same as or different from the number of haptic motors 116 for a dorsal side of the glove 102. It is contemplated for the haptic motor 116 to be located a palmer side of the glove 102 to as to provide a sensation on a user's palmer portion of the hand that is a simulation of the hand making contact with the virtual object.

As will be explained herein, it is contemplated for the flex sensor(s) 114 and the haptic motor(s) 116 to work in an orchestrated manner so as to provide the appropriate/desired tactile sensation(s) as a user flexes their fingers to manipulate the virtual object. This orchestrated operation can be achieved via a processor 118 of the system 100.

The system 100 and/or any of its components can have a processor 118. The processor 118 can be any of the processors disclosed herein. The processor 118 can be part of or in communication with a machine (logic, one or more components, circuits (e.g., modules), or mechanisms). The processor 118 can be hardware (e.g., processor, integrated circuit, central processing unit, microprocessor, core processor, computer device, etc.), firmware, software, etc. configured to perform operations by execution of instructions embodied in algorithms, data processing program logic, artificial intelligence programming, automated reasoning programming, etc. Use of processors 118 herein can include any one or combination of a Graphics Processing Unit (GPU), a Field Programmable Gate Array (FPGA), a Central Processing Unit (CPU), etc. The processor 118 can include one or more sub-processors or processing modules. A sub-processor or processing module can be a software or firmware operating module configured to implement any of the method steps disclosed herein. The sub-processor or processing module can be embodied as software and stored in memory 120, the memory 120 being operatively associated with the processor 118. A sub-processor or processing module can be embodied as a web application, a desktop application, a console application, etc.

The processor 118 can include or be associated with a computer or machine readable medium. The computer or machine readable medium can include memory 120. The computer or machine readable medium can be configured to store one or more instructions thereon. The instructions can be in the form of algorithms, program logic, a model, etc. that cause the processor 118 to perform any of the functions described herein.

Any of the memory 120 discussed herein can be computer readable memory configured to store data. The memory 120 can include a volatile or non-volatile, transitory or non-transitory memory, and be embodied as an in-memory, an active memory, a cloud memory, etc. Embodiments of the memory 120 can include a sub-processor or processor module and other circuitry to allow for the transfer of data to and from the memory 120, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc.

The processor 118 can be in communication with other processors of other devices (e.g., a computer device, a desktop computer, a laptop computer, a computer system, etc.). Any of those other devices can include any of the exemplary processors disclosed herein. Any of the processors 118 can have transceivers or other communication devices/circuitry to facilitate transmission and reception of wireless signals. Any of the processors 118 can include an Application Programming Interface (API) as a software intermediary that allows two applications to talk to each other. Use of an API can allow software of the processor 118 of the system 100 to communicate with software of the processor 118 of the other device(s), if the processor 118 of the system 100 is not the same processor of the other device.

Any data transmission between the processor 118 and memory 120, between the processor 118 and a database, and between the processor 118 and processors 118 of other devices, etc. can be via a pull operation (e.g., the processor 118 can pull the data) or a push operation (e.g., the data can be pushed to the processor 118). The processor 118 can receive the data in streaming format, or store it in memory 120 before being processed. In addition, embodiments of the algorithm, model, etc. disclosed herein can be developed as an application software (an “App”) to be implemented on a processor 118 of a device. The App can be sent via a streaming format, or the App can be sent and stored on a memory associated with or accessed by the device.

As noted herein, the processor 118 can be configured to be a component of, used in combination with, or in communication with another device/system—e.g., this can include the processor 118 being part of the device/system, the device/system being part of the processor 118, the processor 118 in communication with the device/system, etc. “Being part of” can include being on the same substrate or integrated circuit. For instance, the processor 118 can be a component of, used in combination with, or in communication with a predictive modeling system, a decision support system, an automated control system, etc. The processor 118 can use a model or algorithm disclosed herein or provide the model or algorithm to the device/system to assist with or augment the performance of these devices/systems.

The processor 118 can be operatively connected to the motion sensor 110, the haptic feedback device 112, and a virtual reality (VR) display 112. The processor 118 can also be configured to generate one or more virtual objects 124 in space. It is contemplated for the virtual object 124 to be an object within the reference coordinate frame to allow a user donning the glove 102 to manipulate (e.g., sculpt) the virtual object so as to “reshape” the virtual object. For instance, the reference coordinate frame can be a 3D mesh matrix, and the virtual object 124 can be points in the 3D mesh matrix. Thus, the processor 118 can be configured to generate a 3D model of the virtual object 124 within the 3D mesh matrix. With this 3D model, the processor 118 can track movements of the glove 102 and when the glove 102 makes contact with the virtual object 124, it can cause the haptic feedback device 112 to generate appropriate/desired tactile sensations for the user via the glove 102. The processor 118 can also use the 3D model to reshape the virtual object 124 based on the contacts.

For instance, the processor 118 can be configured to receive motion data from the motion sensor 110. The motion data can be representative of a location of the glove 102 relative to a location of the virtual object 124. As can be appreciated, the motion data can be representative of location(s) of one or more forehand portions 106, one or more backhand portions 104, one or more finger portions 108, etc. Accordingly, the tactile sensations can be generated when one or more locations of a forehand portion(s) 106, a backhand portion(s) 104, finger portion(s) 108, etc. intersect with one or more locations of the virtual object 124. The processor 118 can generate control signals to cause the haptic feedback device 112 to generate tactile sensations when the location of the glove 102 intersects the location of the virtual object 124. The processor 118 can then reshape the virtual object 124 based on interactive engagement between the glove 102 and the virtual object 124. These interactive engagements can pertain to a degree with which the glove 102 transects into a volume of space of the virtual object 124. For instance, the processor 118 using the 3D mesh can track how far a potion of the glove 102 (represented by points or vectors in the 3D mesh) transect into the virtual object 124 (also represented by pints or vectors in the 3D mesh), and use interpolation, extrapolation, etc. to calculate new positions of portions/surfaces of the virtual object 124 that had its volume of space transected. The processor118 can then update the matrix points/vectors representative of the virtual object 124 to “reshape” the virtual object 124. As can be appreciated, one or more surfaces of the virtual object 124 can be reshaped based on one or more interactive engagements between a forehand portion(s) 106, a backhand portion(s) 104, finger portion(s) 108, etc. and the one or more surfaces. The one or more interactive engagements can pertain to one or more degrees with which a forehand portion(s) 106, a backhand portion(s) 104, finger portion(s) 108 etc. transect into one or more volumes of space of the virtual object 124. For instance, if the virtual object 124 represents clay for art sculpting, the interactive engagement(s) can allow the processor to determine if and to which degree the clay is molded or sculpted, and use that to reshape the virtual object 124 accordingly. The processor 118 can also cause the haptic feedback device 112 to generate the appropriate tactile sensations to mimic a user actually sculpting clay based on the user's movements. It is understood that the processor 118 can be configured reshape the virtual object in real-time, via a batch-processing technique, continuously, periodically, at a pre-determined time, etc.

The processor 118 can be configured to generate one or more three-dimensional (3D) images of the virtual object(s) 124 for display by the VR display 112. For instance, as the virtual object 124 is being reshaped, the processor 118 can generate an 3D image suitable for display by a VR display—e.g., the processor 118 can generate the 3D image in Extended Display Identification Data (EDID) format based on the 3D model used to reshape the virtual object 124. This 3D image file can be transmitted to the VR display 112. It is contemplated for the VR display 112 to be viewed by persons that are not visually imparted so as to allow them to visualize how the virtual object 124 is being molded and/or see the resultant virtual object 124. The system 100 can include the VR display 112, be in communication with the VR display 112, save the 3D image in memory to be transferred to a VR display 112 at a later time, etc. It is contemplated for the VR display 112 to be a VR headset.

The processor 118 can also be configured to generate a file representative of the resultant virtual object 124 that is suitable for an additive manufacturing process to generate a physical form of the virtual object 124-e.g., the processor 118 can generate a STL, 3MF, AMF, etc. file of the virtual object 124 based on the 3D model used to reshape the virtual object 124.

An exemplary embodiment can relate to a method for sculpting in virtual reality. The method can involve generating a virtual object in space. The method can involve receiving motion data representative of a location of a glove relative to a location of the virtual object. The method can involve generating tactile sensations when the location of the glove intersects the location of the virtual object. The method can involve reshaping the virtual object based on interactive engagement between the glove and the virtual object. The interactive engagement can pertain to a degree with which the glove transects into a volume of space of the virtual object. The method can involve generating a three-dimensional (3D) image of the virtual object for display by a VR display.

### EXAMPLES

The following are exemplary compositions, devices, methods, and implementations of the embodiments disclosed herein. While the examples may focus on one implementation, it is understood that this is exemplary and the embodiments disclosed herein are not limited thereto.

Embodiments of the system disclosed herein may be referred to as “Together, Tacit”.

Blind or Visually Impaired (BVI) artists are often overlooked and underrepresented.

Their unique way of understanding art is very different from a sighted individual creating a disconnect. Together, Tacit can bridge the gap between BVI and sighted individuals. Through sculpting in virtual reality, sighted artists can learn from BVI artists who are given complete creative freedom. Art created by BVI individuals can be displayed, bringing inclusivity and a better understanding of how a BVI artist interprets the world. The Together, Tacit technology can be accessible and easy to use, allowing artists and non-artists alike to express their creative freedom and share their tacit knowledge with others.

An exemplary implementation of the Together, Tacit technology can include a system for sculpting in virtual reality. The system can include a glove, a motion sensor, a haptic feedback device (e.g., a plurality of flex sensors and a plurality of haptic motors), a processor operatively connected to the motion sensor and the haptic feedback device, and a virtual reality display. A motion sensor can be attached to the glove and the haptic feedback device can be attached to each fingertip of the glove. A relative location in a space can be captured by the motion sensor. A surface of an object can be captured by the haptic feedback device. The relative location and surface can be converted to an 3D image by the processor, wherein the 3D image can be projected to the VR display.

The exemplary implementation of the Together, Tacit technology discussed in the Examples section includes three components: hardware, software, and glove design.

### Hardware

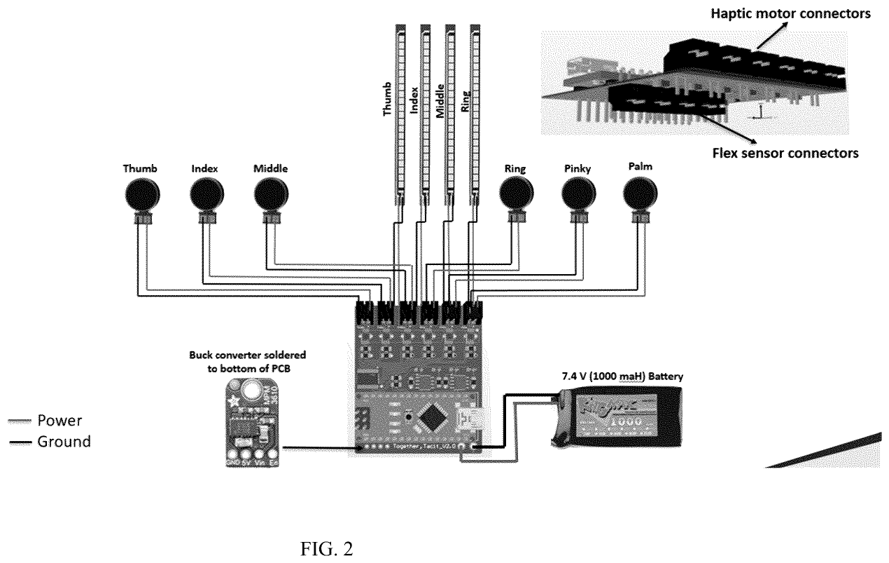

The hardware can be configured such that all components are inside the glove to produce haptic feedback during sculpting. A Printed Circuit Board (PCB) can be used as the processor. The PCB can be split into three major systems: an Arduino platform, flex sensors, and haptic motors. To make the glove completely wireless, a battery and Bluetooth Arduino can be added as well. The exemplary circuit diagram is shown in FIG. 2.

Arduino (an open-source electronics platform configured to allow users to build interactive electronics) can be used as the brain of the glove. In the exemplary implementation, Arduino Nano ESP 32 is selected because it can facilitate communication via wireless protocols (e.g., Bluetooth, Wi-Fi, etc.). The Arduino platform can be powered by a two-cell 1000 milliamp lithium polymer (LiPo) battery. Two cell LiPo batteries can operate at approximately 7.4 volts to power an Arduino platform that requires approximately seven volts. However, motor drivers can only take a maximum of 5.2 volts, so the voltage from the battery may have to be stepped down. To step down the voltage, a five-volt buck converter from Adafruit can be used. The battery can attach to the Vin pin of the buck converter. A constant five volts can be supplied on another pin which runs to the op-amps as well as the motor drivers. Using the buck converter can ensure that the Arduino platform is receiving the required minimum of seven volts to run, while also remaining below the maximum voltages of the other integrated circuits (IE) of the Together, Tacit system.

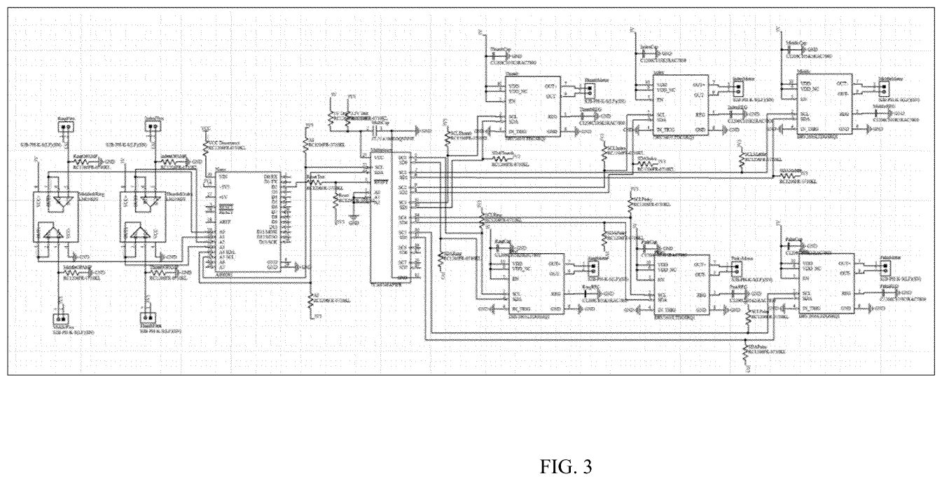

Op-amps, or operational amplifiers, can be used to help to stabilize the voltage readings received from the flex sensors. As seen in the PCB schematic in FIG. 3, each op-amp can support two flex sensors. A constant 3.3 volts can be supplied to one side of the flex sensor which changes resistance depending on how much it is bent. The resulting voltage is then supplied to the op-amp, and the final value goes into one of the analog pins on the Arduino platform. This can be configured as a simple circuit that is reliable over the lifecycle of the glove.

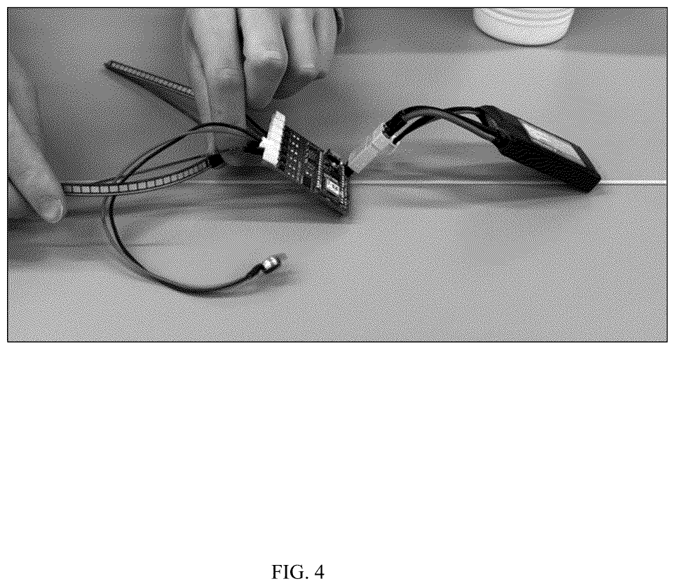

The motor drivers, haptic motors, and multiplexer circuits can be embodied as DRV2605L motor drivers, or haptic motor drivers, which can be controlled through a serial communication (e.g., I²C). To differentiate between each motor driver, a multiplexer can be used. Each channel of the multiplexer can be individually opened, and an I²C signal can be sent. In this circuit, the Arduino platform can use analog pins A4 and A5 for I²C communication which can serve as “clock” and “signal” pins, respectively. These two pins go into the multiplexer to communicate which channel to open and which signal to send over that channel. Each motor driver can be connected to a channel through a pull-up resistor. The multiplexer can be powered directly off of the 3.3-volt pin on the Arduino platform, which can ensure that the multiplexer only turns on when the Arduino platform does. This can facilitate the Arduino platform addressing each motor individually for a better sculpting experience. Test results of the design with flex sensors and haptic motors are shown in FIG. 4. These tests confirm that the PCB is fully operational, and no additional hardware updates are required. Each haptic motor is able to be individually addressed, and the power supplied each component is correct.

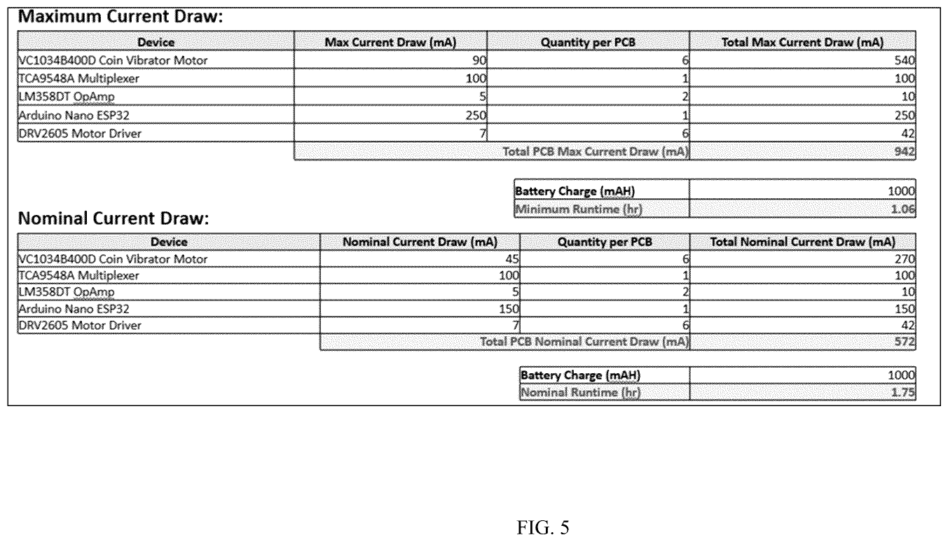

Power analysis results for the PCB design are shown in FIG. 5. Maximum current draw and nominal current draw are used for the results shown in FIG. 5. Because the haptic motors are not running the entire time during sculpting, the nominal case is the most realistic. As can be appreciated, the system can run for approximately 1.75 hours before the battery must be charged during normal operation.

### Software

The software system includes both Arduino and Unity code. The software system can be made up of three main components: Unity, Arduino, and the headset. Unity is a game-development application used for creating visuals and gathering user input. Arduino code is used to connect the hardware in the glove to both Unity and the headset. This program is responsible for the haptic feedback the BVI user feels. Oculus is used for the headset. The sculpting program is loaded on as an app and it can be run completely on its own without the help of a computer.

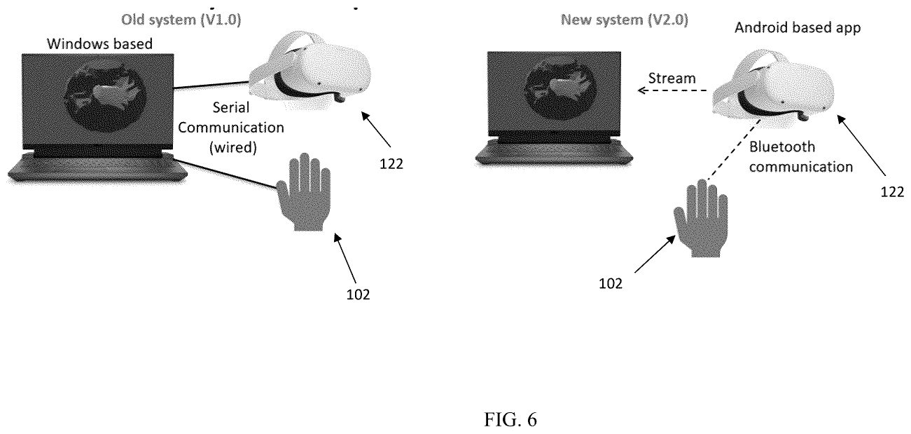

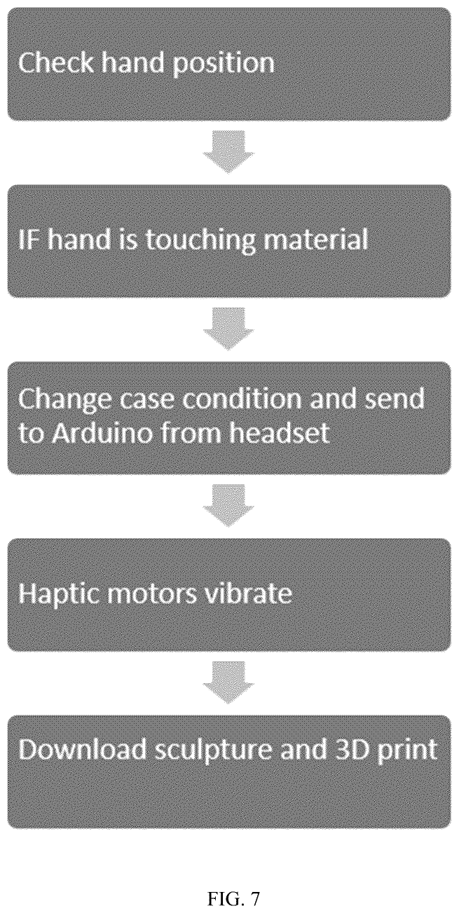

As seen in FIG. 6, the Unity code is altered to receive inputs from the wireless Arduino platform on the glove instead of the serial ports. A Bluetooth connectivity package is also used. With this set-up, the glove can successfully connect to the Arduino platform via Bluetooth. Cases are sent to the Arduino platform that detail the hand position in game. This can allow the Arduino platform to activate the haptic motors whenever the glove-wearer enters the sculpture. This process is shown in FIG. 7.

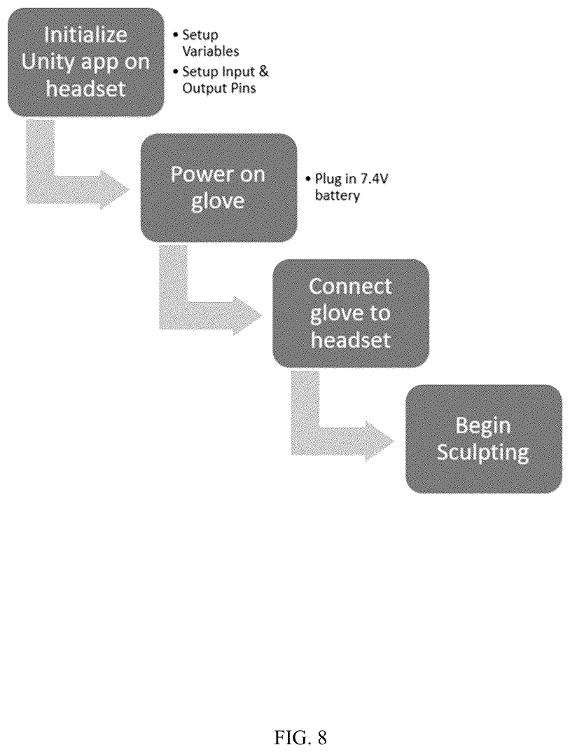

The system can be set up to implement the game as an app directly on the headset, but also, or in the alternative, streaming it from a laptop. To export the game as an app, the program is packaged into an .apk file in Unity. This can be done by navigating to File>Project Settings>Android>Build. To load the package onto the headset, a Side Quest application is used. Once the program is packaged into an. apk, Side Quest can then load the app onto the headset as long as the headset is plugged into the computer. Using this app-based approach, starting up the program just requires a few clicks. The initialization approach is shown in FIG. 8. Streaming from the headset is the primary method for presentation purposes which is detailed in the instructions.

### Glove Design

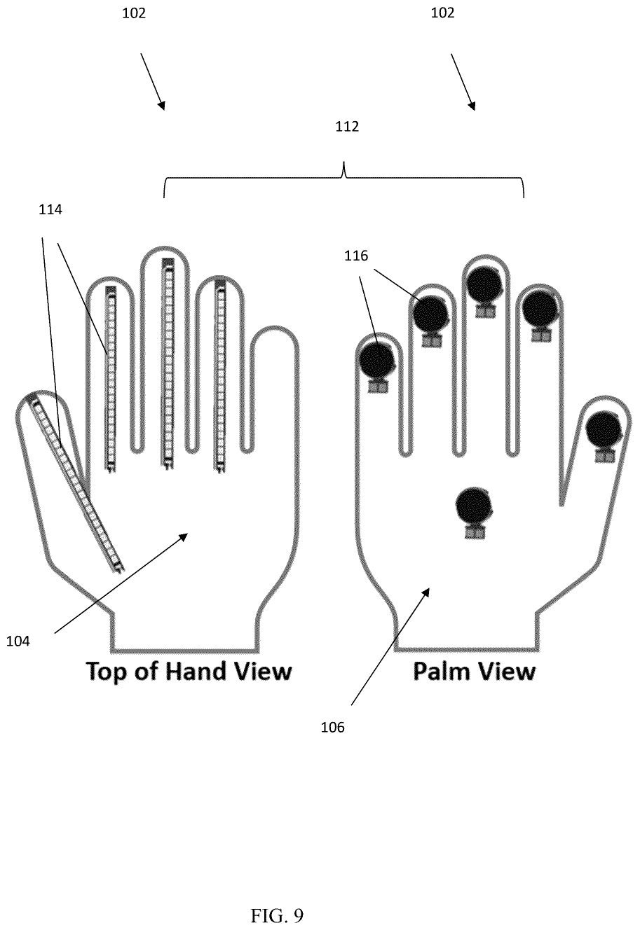

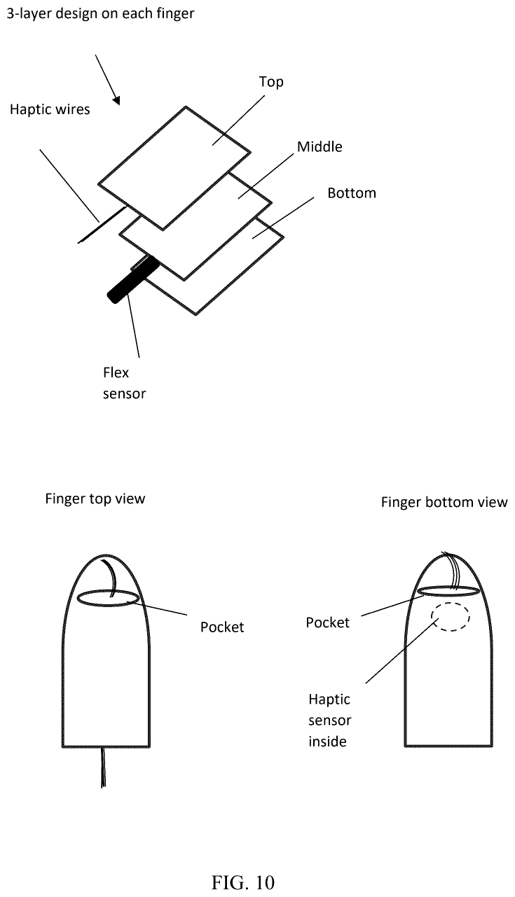

The glove design includes the construction of the glove itself and all 3D printed parts to hold hardware and equipment. For hardware placement, the flex sensors can be placed on the top of the hand, while the haptic motors can be placed on the palm. An exemplary placement of the sensors and motors is shown in FIG. 9. To conceal this hardware, the glove can have a three-layer design on each finger detailed in FIG. 10.

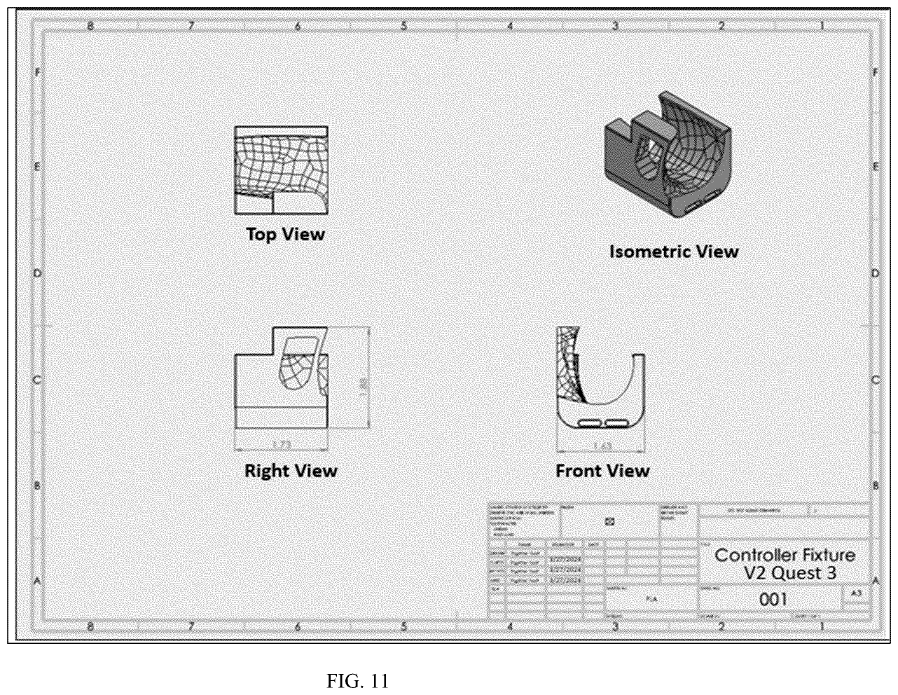

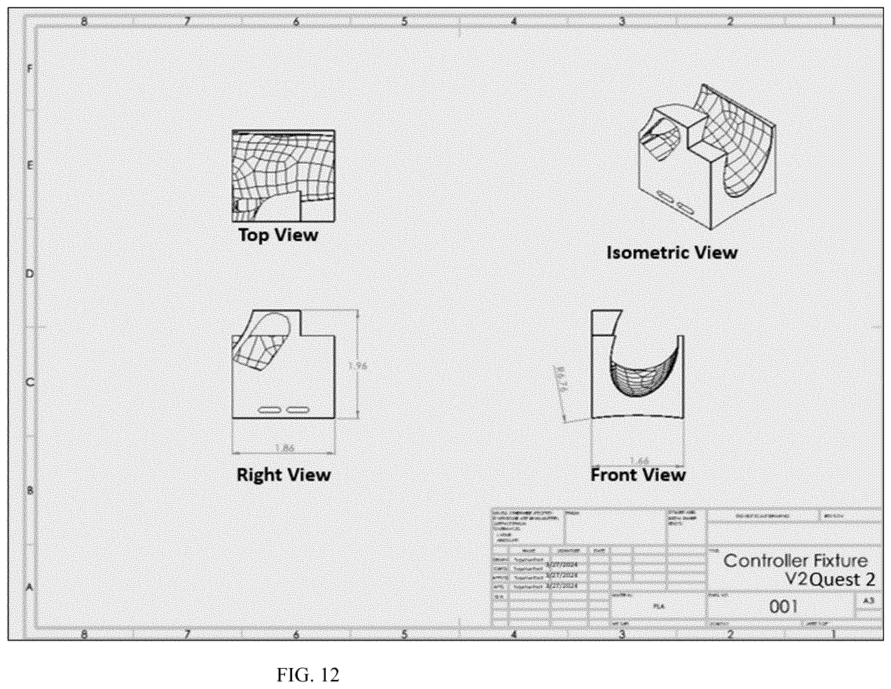

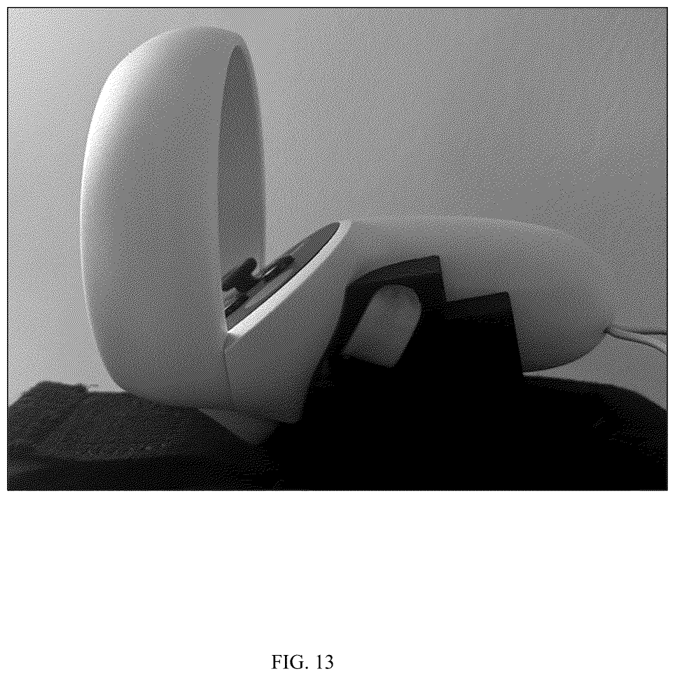

To secure the PCB and Oculus Controller, 3D printed designs are modeled in SolidWorks. For the controller, a fixture is designed for both the Quest 2 and Quest 3. A Quest 3 controller fixture is shown in FIG. 11, and a Quest 2 controller fixture is shown in FIG. 12. The Quest 2 fixture is configured with a vertical up right orientation and a curved bottom for more comfort on the hand. The 3D printed fixture is seen in FIG. 13 with the Quest 2 controller.

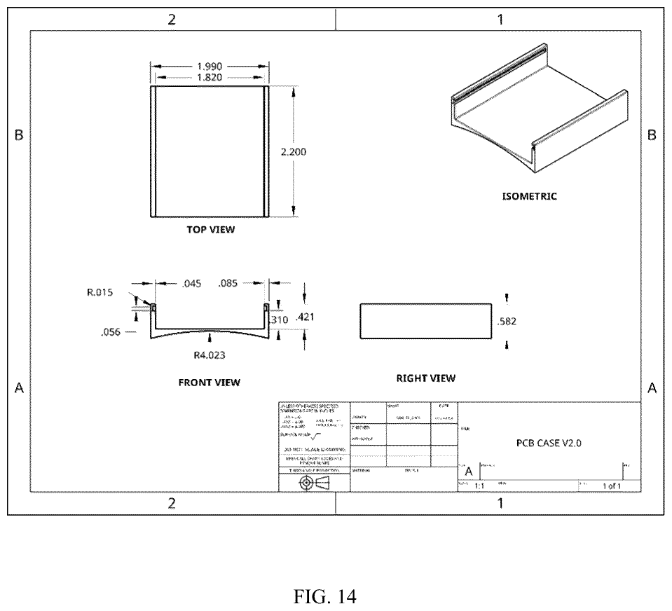

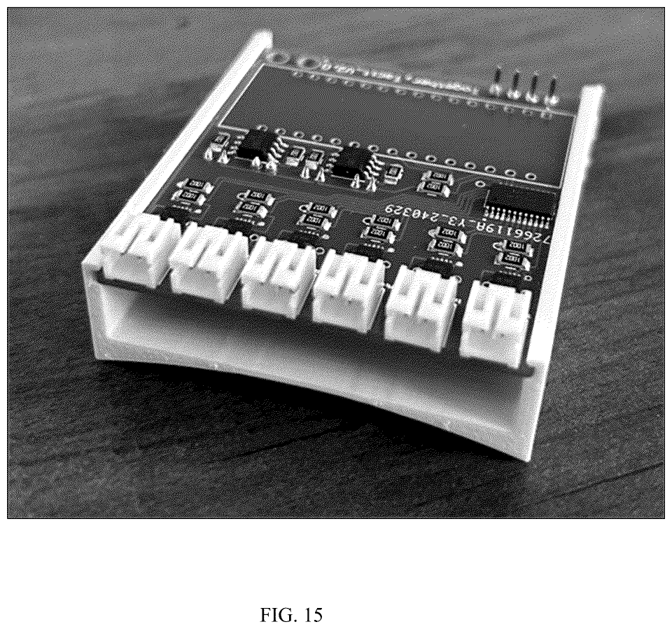

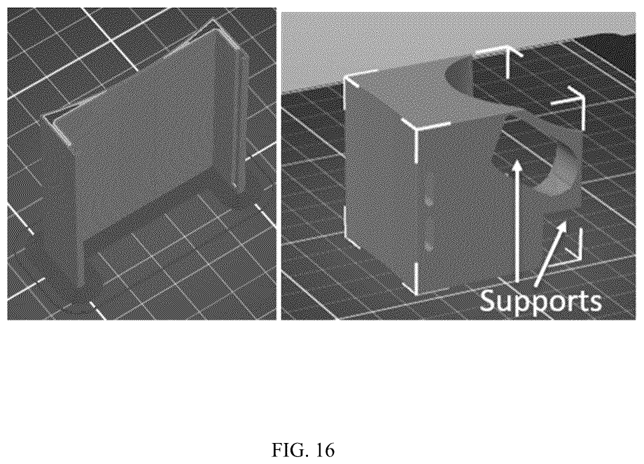

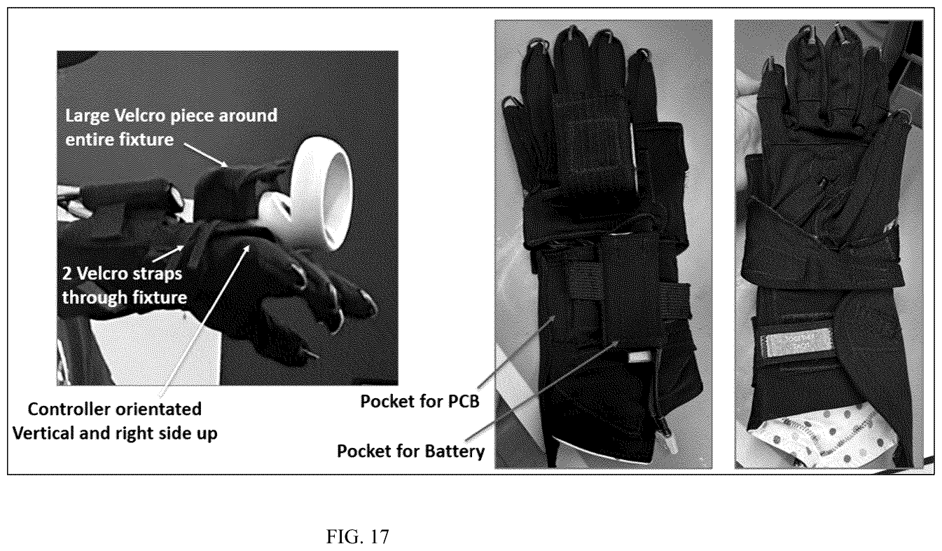

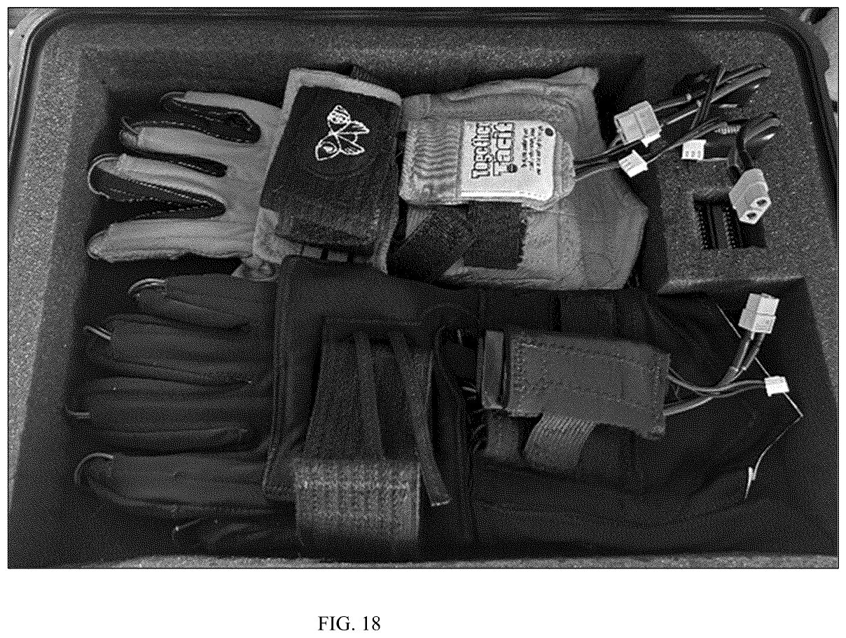

A platform designed to hold the PCB is shown FIG. 14. The PCB slides into the platform with easy access to all hardware and connectors, as seen in FIG. 15. This platform can tuck into the pocket on the wrist of the glove described later. All 3D prints are completed on an Original Prusa i3 MK3S. The settings for the PCB casing are 0.15 mm QUALITY, Generic Polylactic Acid (PLA) filament, no supports, 15% infill, and with a brim. For the Quest 2 controller fixture, the settings are 0.20 mm QUALITY, Generic PLA filament, supports only on the button area and below, 15% infill, and no brim. The orientation for each print is shown in FIG. 16. The areas where supports are added to the controller fixture are also seen in FIG. 16. The placement of the PCB, battery, and controller fixture is detailed in FIG. 17. The PCB and its case go inside a pocket on the wrist. The battery has a separate pocket that goes above the PCB pocket. The controller fixture has Velcro straps and a band to secure the controller to the hand. In the FIGS, the black glove is the large size, and the blue glove is the small size. Both gloves are identical in hardware and software. The fully assembled gloves are shown in FIG. 18. The glove conceals all wiring and hardware making it a well-crafted design.

It should be understood that the disclosure of a range of values is a disclosure of every numerical value within that range, including the end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the compositions, materials, apparatuses, and methods of using and making the same disclosed herein have been discussed and illustrated, it is to be distinctly understood that the invention is not limited thereto but may be otherwise variously embodied and practiced within the scope of the following claims.

What is claimed is:

1. A system for sculpting in virtual reality, the system comprising:
a glove, comprising a forehand portion, a backhand portion, and finger portions;
a motion sensor;
a haptic feedback device, comprising a plurality of flex sensors and a plurality of haptic motors;
a processor operatively connected to the motion sensor, the haptic feedback device, and a virtual reality (VR) display, wherein the processor is configured to:
generate a virtual object in space;
receive motion data from the motion sensor, the motion data being representative of a location of the glove relative to a location of the virtual object;
cause the haptic feedback device to generate tactile sensations when the location of the glove intersects the location of the virtual object;
reshape the virtual object based on interactive engagement between the glove and the virtual object, the interactive engagement pertaining to a degree with which the glove transects into a volume of space of the virtual object;
generate a three-dimensional (3D) image of the virtual object for display by the VR display.

2. The system of claim 1, further comprising the VR display.

3. The system of claim 1, wherein the VR display is a VR headset.

4. The system of claim 1, wherein the processor is configured to transmit the 3D image to the VR display.

5. The system of claim 1, wherein the processor is configured reshape the virtual object in real-time, via a batch-processing technique, continuously, periodically, or at a pre-determined time.

6. The system of claim 1, wherein the motion data is representative of a location of the forehand portion, the backhand portion, and/or the finger portions.

7. The system of claim 6, wherein the tactile sensations are generated when one or more locations of the forehand portion, the backhand portion, and/or the finger portions intersect with one or more locations of the virtual object.

8. The system of claim 7, wherein one or more surfaces of the virtual object is reshaped based on one or more interactive engagements between the forehand portion, the backhand portion, and/or the finger portions and the one or more surfaces, the one or more interactive engagements pertaining to one or more degrees with which the forehand portion, the backhand portion, and/or the finger portions transect into one or more volumes of space of the virtual object.

9. The system of claim 1, wherein the processor is configured to generate plural virtual objects and plural 3D images of the plural virtual objects.

10. The system of claim 1, wherein the motion sensor is located in or on the glove.

11. The system of claim 1, wherein at least one flex sensor is located in or on one or more finger potions.

12. The system of claim 1, wherein one or more haptic motors is located in or on the forehand portion.

13. A method for sculpting in virtual reality, the method comprising:
generating a virtual object in space;
receiving motion data representative of a location of a glove relative to a location of the virtual object;
generating tactile sensations when the location of the glove intersects the location of the virtual object;
reshaping the virtual object based on interactive engagement between the glove and the virtual object, the interactive engagement pertaining to a degree with which the glove transects into a volume of space of the virtual object;
generating a three-dimensional (3D) image of the virtual object for display by a VR display.

14. The method of claim 13, wherein the VR display is a VR headset.

15. The method of claim 13, further comprising transmitting the 3D image to the VR display.

16. The method of claim 13, wherein reshaping the virtual object involves reshaping the virtual object in real-time, via a batch-processing technique, continuously, periodically, or at a pre-determined time.

17. The method of claim 1, wherein the motion data is representative of a location of a forehand portion of the glove, a backhand portion of the glove, and/or finger portions of the glove.

18. The method of claim 17, wherein generating tactile sensations involves generating tactile sensations when one or more locations of the forehand portion, the backhand portion, and/or the finger portions intersect with one or more locations of the virtual object.

19. The method of claim 17, wherein reshaping the virtual object involves reshaping one or more surfaces of the virtual object based on one or more interactive engagements between the forehand portion, the backhand portion, and/or the finger portions and the one or more surfaces, the one or more interactive engagements pertaining to one or more degrees with which the forehand portion, the backhand portion, and/or the finger portions transect into one or more volumes of space of the virtual object.

20. The method of claim 13, further comprising generating plural virtual objects and generating plural 3D images of the plural virtual objects.
